(19) United States
(12) Patent Application Publication
(10) Pub. No.: US 2002/0035198 A1
(43) Pub. Date: Mar. 21, 2002

(54) Novel water-soluble (co) polymers containing quaternary amino groups, their manufacture and their use

(75) Inventors: Denis Tembou N'Zudie, Serquigny (FR); Yvon Legrand, Lievin (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 09/922,944

(22) Filed: Aug. 7, 2001

(30) Foreign Application Priority Data
Aug. 7, 2000 (FR) 0010388

(51) Int. Cl. C08F 226/02

(52) U.S. Cl. 524/555; 524/801; 524/815; 526/312

(57) ABSTRACT

A water-soluble cationic (co)polymer is obtained from a monomer composition comprising, per 100 parts by moles, from 0 to 95 parts of at least one water-soluble monomer of formula (I); 0.20 to 100 parts of at least one cationic water-soluble monomer of formulae (II) or (III); 0 to 60 parts of at least one water-soluble monomer which is potentially anionic by varying the pH; 0 to 90 parts of at least one cationic water-soluble monomer containing only one quaternary amino, of formula (IV); 0 to 10 parts of at least one hydrophobic monomer; 0 to 30 parts by moles of at least one other water-soluble monomer formulae I-IV are defined herein.

The present invention relates to novel (co)polymers containing quaternary amino groups, which are especially in the form of inverse emulsions, powders and aqueous solutions, to processes for preparing these novel (co)polymers, and to the use of these polymers for flocculation, in particular in the field of urban and industrial residual waste waters, the papermaking industry, mines and quarries, drilling muds, the assisted recovery of petroleum, and drinking water.

To satisfy these applications, cationic water-soluble polymers have already been proposed and sold in four presentation types:

(1) in inverse emulsion form, that is to say in the form of a dispersion in oil of water-soluble polymer particles stabilized with surfactants. The preparation of these products is obtained according to an inverse emulsion process described, for example, in American patents U.S. Pat. No. 3,284,393 and U.S. Pat. No. 5,292,800;

(2) in the form of an aqueous solution obtained by homogeneous aqueous solution polymerization according to a procedure commonly known as the gel process, which leads to a hydrated gel which may be readily diluted in water and sold in the form of a dilute aqueous solution (for example American patent U.S. Pat. No. 5,422,408);

(3) in the form of an aqueous dispersion also known as a water/water emulsion, that is to say an aqueous dispersion of water-soluble polymer particles stabilized with a dispersant copolymer of low mass.. The synthetic process is described, for example, in French patent application FR-A-2 770 526;

(4) in powder form, by drying the gel obtained from the gel process, by inverse suspension polymerization, by spraying the inverse emulsions and aqueous dispersions (for example American patent U.S. Pat. No. 5,696,228).

These polymers are generally obtained by copolymerization of:

(a) 0 mol % to 95 mol % of at least one from among (meth)acrylamide and (meth)acrylamide derivatives, for instance N-substituted (meth)acrylamides (for example N-isopropylacrylamide or N-ethoxypropyl-acrylamide) and N,N-substituted (meth)acrylamides;

(b) 5 mol % to 100 mol % of one or more cationic monomers containing a quaternary amino group of general formula:

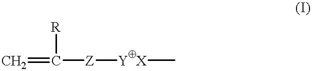

in which:

R represents H or methyl;

Z represents an electron-withdrawing divalent group which is capable of activating free-radical polymerization;

Y^{⊕} represents a cationic monovalent group; and

X— represents an anion; and

(c) 0 mol % to 30 mol % of one or more potentially anionic monomers, for instance carboxylic acids containing ethylenic unsaturation, for example (meth)acrylic acid.

The monomers containing tertiary or quaternary amino groups which are used for the preparation of the water-soluble cationic copolymers described in the above documents contain a single quaternary amino group per molecule. In contrast with these known structures, the Applicant Company has now discovered that other monomers containing two quaternary amino groups or one quaternary amino group combined with a tertiary amino group may be used for the preparation of novel water-soluble cationic copolymers, which may be in the form of inverse emulsions, powders or aqueous solutions.

A subject of the present invention is thus, firstly, a water-soluble cationic (co)polymer, characterized in that it is obtained from a monomer composition comprising, per 100 parts by moles:

(A) from 0 to 95 parts by moles of at least one water-soluble monomer of formula (I):

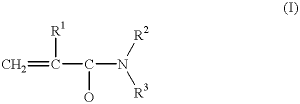

in which:

R¹ represents H or-CH₃; and

R² and R³, which may be identical or different, each independently represent H, C₁-C₅ alkyl optionally comprising one or more OH groups, or (C₁-C₅) alkoxy(C₁-C₅) alkyl;

(B) 0.20 to 100 parts by moles of at least one cationic water-soluble monomer chosen from those of formulae (II) and (III) below:

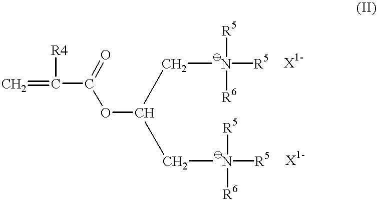

in which:

R⁴ represents H or -CH₃;

R⁵ and R⁶, which may be identical or different, each independently represent H, C₁-C₁₈ alkyl, benzyl(-CH₂-C₆H₅) or hydroxyethyl; and

X¹- represents a monovalent anion, such as Cl— or Br—;

R⁸

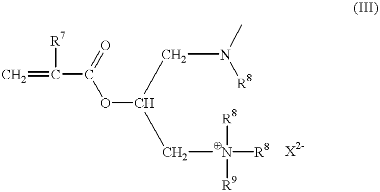

in which:

R⁷ represents H or -CH₃;

R⁸ and R⁹, which may be identical or different, each independently represent hydrogen, C₁-C₁₈ alkyl, benzyl(-CH₂-C₆H₅) or hydroxyethyl; and

X²- represents a monovalent anion, such as Cl— or Br—;

(C) 0 to 60 parts by moles of at least one water-soluble monomer which is potentially anionic by varying the pH;

(D) 0 to 90 parts by moles of at least one cationic water-soluble monomer containing only one quaternary amino group, of formula (IV):

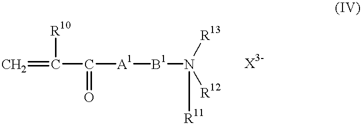

in which:

R¹⁰ represents H or -CH₃;

A¹ represents -O- or -NH-;

B¹ represents CH₂-CH₂ -, -CH₂-CH₂CH₂- or -CH₂-CHOH-CH₂-;

R¹¹ and R¹², which may be identical or different, each independently represent -CH₃ or a C₂-C₁₆ alkyl group;

R¹³ represents hydrogen, -CH₃ or a C₂-C₁₆ alkyl group; and

X³- is a monovalent anion, such as Cl— or Br—;

(E) 0 to 10 parts by moles of at least one hydrophobic monomer; and

(F) 0 to 30 parts by moles of at least one water-soluble monomer other than the monomers (A), (B), (C) and (D).

The compound(s) (A) of formula (I) is(are) preferably chosen from acrylamide, methacrylamide, N-isopropylacrylamide, N-ethoxypropylacrylamide, N,N-dimethylacrylamide, N-(2-hydroxypropyl)acrylamide and N-(2-hydroxypropyl)methacrylamide. Acrylamide is particularly preferred.

The monomer(s) (B) of formula (II) is(are) chosen in particular from those for which:

R⁴ represents H ;

R⁵ represents -CH₃ ;

R⁶ represents -CH₃ or benzyl; and

X represents Cl; and the monomer(s) (B) of formula (III) is(are) chosen in particular from those for which:

R⁷ represents H ;

R⁸ represents -CH₃ ;

R⁹ represents -CH₃ or benzyl; and

X represents Cl.

The monomer(s) (C) is(are) chosen in particular from ethylenically unsaturated carboxylic acids and salts thereof, for instance acrylic acid and salts thereof, and ethylenically unsaturated sulphonated monomers and salts thereof, for instance 2-acrylamido-2-methylpropane-sulphonic acid and its salts. The salts here are, in particular, the alkali metal salts, such as the sodium and potassium salts.

The monomer(s) (D) is(are) chosen in particular from the (meth)acryloyloxyethyltrimethylammonium halides (in particular the chlorides).

The monomer(s) (E) is(are) chosen in particular from alkyl (meth)acrylates, such as ethyl acrylate and butyl acrylate, and vinylaromatic monomers, such as styrene.

The water-soluble monomers (F) are chosen in particular from polyethoxylated (meth)acrylates, polyethoxylated (meth)acrylates containing hydrophobic units (such as an alkyl chain) or aryl units, and N-vinylpyrrolidone. Mention may be made in particular of polyethoxylated methacrylates containing 8, 12, 22 and 44 ethylene oxide units.

The (co)polymer according to the invention is in the form of a dispersion in an organic solvent, an aqueous solution or a powder, depending on the particular process for its manufacture.

The subject of the present invention is also a process for manufacturing a copolymer as defined above, characterized in that a free-radical (co)polymerization of the monomer(s) as defined above is carried out by inverse emulsion polymerization leading to a dispersion of the water-soluble (co)polymer in an organic solvent, or by aqueous solution polymerization leading to a polymer in the form of an aqueous solution or a powder.

In the inverse emulsion polymerization process, the monomer(s) is(are) emulsified in an organic phase using at least one organosoluble emulsifier, followed by emulsion polymerization.

The organic phase consists of an inert hydrophobic liquid and generally represents from 10% to 49% and preferably from 20% to 40% of the total weight of the emulsion. The inert hydrophobic liquid may be chosen from a large range of organic liquids comprising liquid hydrocarbons and substituted liquid hydrocarbons, preferably containing 4 to 8 carbon atoms or even more than 8 carbon atoms. Xylene, toluene, mineral oils, kerosene, heavy spirits and, in certain cases, petroleum may be used, for example. The petroleum fractions and in particular the branched-chain isoparaffinic fraction sold under the registered trademark <<ISOPAR^{®} M>> are particularly advantageous.

Suitable organosoluble emulsifiers are those which have an HLB (hydrophilic-lipophilic balance) value of between 2 and 10 and preferably between 3 and 9. For the definition of the HLB, reference may be made to the article by W. C. Griffin in <<Journal of Society of Cosmetic Chemist>>, Volume 1, page 311 (1950). Examples which may be mentioned are fatty acid esters of mono-, di- and polyglycerols, for instance the monooleate, the dioleate, the monostearate, the distearate and the palmitate-stearate. These esters may be prepared, for example, by esterifying mono-, di- and polyglycerols, or mixtures of polyhydroxylated alcohols such as ethylene glycol, diethylene glycol, dipropylene glycol, 1,4-butanediol, 1,2,4-butanetriol, glycerol, trimethylolpropane, sorbitol, neopentyl glycol and pentaerythritol. In addition, mention may be made of fatty acid esters of sorbitan, for instance sorbitan monooleate, sorbitan dioleate, sorbitan trioleate, sorbitan monostearate and sorbitan tristearate.

Fatty acid esters of mannitol, for instance mannityl monolaurate or mannityl monopalmitate, fatty acid esters of pentaerythritol, for instance pentaerythrityl monomyristate, pentaerythrityl monopalmitate or pentaerythrityl dipalmitate, fatty acid esters of polyethylene glycol sorbitan, more particularly the monooleate and trioleate, fatty acid esters of glucose, for instance glucose monooleate and glucose monostearate, trimethylolpropane distearate, the products of the reaction of isopropylamide with oleic acid, fatty acid esters of glycerolsorbitan, ethoxylated alkylamines, sodium hexadecyl phthalate and sodium decyl phthalate may also be suitable as emulsifiers.

The polymerization temperature depends on the decomposition kinetics of the initiator used and is generally between 10 and 100° C. and preferably between 30 and 90° C.

The process is preferably performed in the absence of oxygen. A flow of inert gas, such as nitrogen or argon, may thus be used to flush the installation.

The polymerization is advantageously carried out in the presence of at least one initiator, used in particular in a proportion of from 0.01% to 2% and preferably from 0.02% to 0.5% relative to the total weight of monomer(s). The initiator(s) is/are generally chosen from peroxides, peresters, azo compounds and diazo compounds belonging to the family of azodicarboxylic acid esters.

Peroxides which may be mentioned are benzoyl peroxide, lauroyl peroxide and succinyl peroxide. A perester which may be mentioned is tert-butyl perpivalate. Azo initiators which may be mentioned are azo-2,2′-bis(isobutyronitrile), azo-4,4′-bis(4-cyano-pentanoic acid) and azobis(amidinopropane). As diazo initiators belonging to the family of azocarboxylic acid esters, mention may be made of those represented by formula (V):

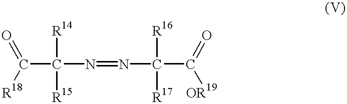

in which:

R¹⁴, R¹⁵, R¹⁶ and R¹⁷, which may be identical or different, each independently represent:

linear or branched alkyl containing from 1 to 9 carbon atoms and preferably from 1 to 4 carbon atoms, optionally substituted with one or more substituents chosen from hydroxyl, C₁ to C₆ alkoxy and halogen;

C₁ to C₆ cycloalkyl;

C₁ to C₆ alkoxy;

hydroxyl;

halogen;

aralkyl optionally substituted with one or more substituents chosen from C₁ to C₆ alkyl, C₁ to C₆ alkoxy, hydroxyl and halogen,

at least one of the combinations R¹⁴-R¹⁵ and R¹⁶-R¹⁷ possibly forming an aliphatic ring; and

R¹⁸ and R¹⁹, which may be identical or different, each independently represent a linear or branched C₁-C₁₀ and preferably C₁ to C₄ aliphatic radical.

Diethyl 2,2′-azobisisobutyrate (compound of formula (V) with R¹⁴ to R¹⁷ each representing methyl and R¹⁸ and R¹⁹ representing ethyl) is particularly preferred as diazo initiator.

The advantage of these azocarboxylic acid esters is their low melting point, which is generally less than 27° C.

In the aqueous solution polymerization process (also known as the gel process), a stationary polymerization is carried out in water, at a monomer concentration of greater than 10% by weight and preferably from 20% to 60% by weight, and in the presence of at least one water-soluble initiator in a proportion of from 0.01% to 2% by weight and preferably from 0.02% to 0.5% by weight relative to the monomer(s), the said polymerization leading to a polymer in the form of a hydrated gel which may be diluted with water to obtain a water-soluble aqueous solution with a concentration typically of less than 6%, or cut to size or precipitated and dried to obtain a powder. The polymer obtained has a high molar mass, in particular from 1 million to 10 million.

The water-soluble initiator(s) is(are) chosen in particular from peroxides such as aqueous hydrogen peroxide solution, persalts, such as persulphates, and azo compounds, such as 4,4′-azobis(cyano-4-pentanoic acid) and azobis(amidino propane) hydrochloride, these initiators possibly being combined with organosoluble initiators, in particular diazo initiators such as those mentioned above for the inverse emulsion polymerization.

The water-soluble initiator(s) may also be combined with polymerization activators preferably chosen from metabisulphites and Fe²⁺, to initiate the polymerization at low temperatures.

The polymerization is carried out at a temperature of between 3 and 100° C. and preferably between 5 and 95° C. It is preferable to use an adiabatic polymerization mode which consists in initiating the polymerization at low temperature, in particular between 5 and 20° C., and leaving the polymerization to proceed without heating or cooling the reaction medium, thus resulting in an increase in the temperature of the reaction medium due to the heat released by the polymerization reaction.

The subject of the present invention is also the use of a (co)polymer as defined above or prepared by a process as defined above, irrespective of the presentation of the said (co)polymer, as a flocculant in the purification of urban and industrial waste waters, in the papermaking industry, in mines, quarries and drilling muds, in the assisted recovery of petroleum and in the treatment of drinking water.

The examples which follow illustrate the present invention without, however, limiting their scope. In these examples, percentages and parts are on a weight basis except where otherwise mentioned, and the following abbreviations have been used:

DEAB: diethyl 2,2′-azobisisobutyrate (azo initiator)

EDTA: ethylenediaminetetraacetic acid

ADAMQUAT MC 80: aqueous solution containing 80% by weight of acryloyloxyethyl-trimethylammonium chloride:

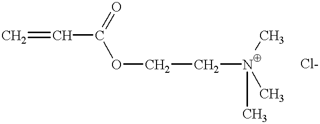

S-ADAMQUAT 2BZ: compound of formula:

[chemical structure]

In Examples 1 and 2, an amount introduced indicated in parts corresponds to 100 parts of monomers.

ISOPAR® M: paraffinic hydrocarbon sold by the company <<EXXON>> (organic phase).

SPAN® 80: sorbitan monooleate sold by the company <<ICI>> (organosoluble emulsifier).

TWEEN® 61: polyethoxylated sorbitan monostearate containing 4 mol of ethylene oxide, sold by the company <<ICI>>.

### EXAMPLE 1

### INVERSE EMULSION

(a) Preparation of the aqueous phase:

The following products are successively introduced into a beaker with stirring:

Demineralized water . . . 165.93 g

Aqueous 50% acrylamide solution . . . 296.81 g

ADAMQUAT MC 80 at 80% in water . . . 33.17 g

Aqueous 75% S-ADAMQUAT 2BZ solution . . . 27.61 g

EDTA (complexing agent) . . . 0.08 g

Adipic acid . . . 11.86 g

Aqueous 50% NaOH solution . . . 1.59 g

NaCl . . . 11.86 g

(b) Preparation of the oil phase:

The following products are successively introduced into a 1 litre Wolff flask:

ISOPAR® M . . . 207.75 g

SPAN® 80 . . . 17.50 g

TWEEN® 61 . . . 2.07 g

(c) Preparation of the pre-emulsion:

The aqueous phase prepared above is poured into the oil phase. The two phases are homogenized using an Ultra-Turrax® mixer for 2 minutes.

(d) Polymerization reaction:

The pre-emulsion obtained above is poured into a polymerization reactor equipped with twin turbomixer stirring set at 500 rpm, a condenser and a dip tube fed with nitrogen. The pre-emulsion is then maintained for 30 minutes under a stream of nitrogen and the temperature is brought to 47° C. DEAB (0.15 part) is then introduced while keeping the temperature of the reaction medium at 47° C.±2° C. for 2 h 30 min. A stage at 52.5° C. for 1 hour and a second stage at 80° C. also for 1 hour are then carried out. The reaction medium is then cooled to room temperature and emptied from the reactor while filtering the mixture through a 10 micron filter.

The emulsion is characterized by:

a solids content of 25%;

an intrinsic viscosity of 12.5 (dl/l); and

a zero coagulum content.

### EXAMPLE 2

### INVERSE EMULSION

The process is performed in the same way as in Example 1, except that the following amounts are used to prepare the aqueous phase:

Demineralized water . . . 165.93 g

Aqueous 50% acrylamide solution . . . 306.15 g

ADAMQUAT MC 80 at 80% in water . . . 39.87 g

Aqueous 75% S-ADAMQUAT 2BZ solution . . . 14.24 g

EDTA . . . 0.08 g

Adipic acid . . . 11.86 g

Aqueous 50% NaOH solution . . . 1.59 g

NaCl . . . 11.86 g

The emulsion obtained is characterized by:

a solid content of 25%;

an intrinsic viscosity of 12.5 (dl/l); and

a zero coagulum content.

### EXAMPLE 3

### ADIABATIC SOLUTION POLYMERIZATION ACCORDING TO THE GEL PROCESS

The following reagent solutions are prepared:

ammonium persulphate (primer) solution 0.033 g of ammonium persulphate is diluted in 25 ml of demineralized water;

sodium metabisulphite (activator) solution 0.033 g of sodium metabisulphite is diluted in 25 ml of demineralized water;

Fe²⁺ (activator) solution 0.12 g of Mohr salt is diluted in 100 ml of demineralized water.

The following are introduced, in order and with stirring, into a 1 litre stainless steel flask cooled with an ice bath:

108.1 g of demineralized water;

160 g of aqueous 50% acrylamide solution;

17.87 g of ADAMQUAT MC 80 at 80% in water; and

14.88 g of aqueous 75% S-ADAMQUAT 2BZ solution.

The solution is degassed by sparging with nitrogen and aluminium foil is then placed over the flask. The temperature of the solution is brought to about 10° C. and the ammonium persulphate solution prepared above is added. Accurately weighed (about 0.1 g) DEAB (post-initiator) is then added.

Exactly 1.2 g of the Fe²⁺ salt solution prepared above are introduced into the sodium metabisulphite solution prepared above.

A polyethylene bag is placed in a 1 litre Dewar® flask and the flask is degassed for a few minutes with nitrogen.

When the reaction mixture has reached 10° C., it is transferred into the polyethylene bag in the Dewar® flask and the degassing with nitrogen and the temperature probe (fitted with a glass follower) are left. The sodium metabisulphite solution prepared above is added and the mixture is stirred vigorously with the follower for 5 seconds to homogenize, before the gel sets. The bubbling with nitrogen is stopped and the exothermicity is monitored.

The reaction is left to continue for at least 5 hours.

The gel recovered may be diluted with water to obtain an aqueous solution of water-soluble polymer of low concentration (2 to 5%) or cut into small pieces and dried to obtain powder, or precipitated from acetone and cut into small pieces before being dried to obtain powder.

The polymer has an intrinsic viscosity of 2.6 (dl/l).

### EXAMPLE 4

### ADIABATIC SOLUTION POLYMERIZATION ACCORDING TO THE GEL PROCESS

The process is performed in the same way as in Example 3, except that the following are used:

20.84 g of ADAMQUAT MC 80 at 80% in water; and

7.45 g of aqueous 75% S-ADAMQUAT 2BZ solution.

The polymer has an intrinsic viscosity of 2.6 (dl/l).

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all applications, patents and publications, cited above and below, and of corresponding French application 00/10388, filed Aug. 7, 2000, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

1. Water-soluble cationic (co)polymer, characterized in that it is obtained from a monomer composition comprising, per 100 parts by moles:
(A) from 0 to 95 parts by moles of at least one water-soluble monomer of formula (I): 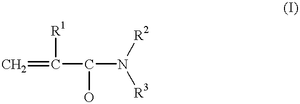
in which:
R¹ represents H or-CH₃; and
R² and R³, which may be identical or different, each independently represent H, C₁-C₅ alkyl optionally comprising one or more OH groups, or (C₁-C₅) alkoxy(C₁-C₅) alkyl;
(B) 0.20 to 100 parts by moles of at least one cationic water-soluble monomer chosen from those of formulae (II) and (III) below: 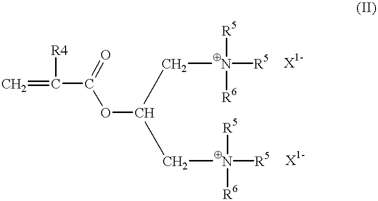
in which:
R⁴ represents H or -CH₃ ;
R⁵ and R⁶, which may be identical or different, each independently represent H, C₁-C₁₈ alkyl, benzyl or hydroxyethyl; and
X¹- represents a monovalent anion; 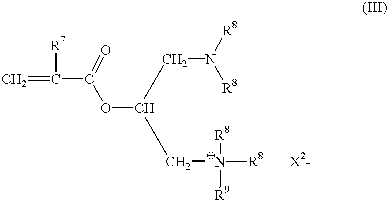
in which:
R⁷ represents H or -CH₃;
R⁸ and R⁹, which may be identical or different, each independently represent hydrogen, C₁-C₁₈ alkyl, benzyl or hydroxyethyl; and
X²- represents a monovalent anion;
(C) 0 to 60 parts by moles of at least one water-soluble monomer which is potentially anionic by varying the pH;
(D) 0 to 90 parts by moles of at least one cationic water-soluble monomer containing only one quaternary amino group, of formula (IV): 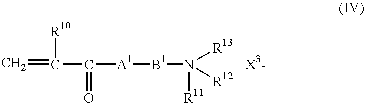
in which:
R¹⁰ represents H or -CH₃;
A¹ represents -O- or -NH-;
B¹ represents CH₂-CH₂-, -CH₂-CH₂CH₂- or -CH₂-CHOH-CH₂ -;
R¹¹ and R¹², which may be identical or different, each independently represent -CH₃ or a C₂-C₁₆ alkyl group;
R¹³ represents hydrogen, -CH₃ or a C₂-C₁₆ alkyl group; and
X³- is a monovalent anion, such as Cl— or Br—;
(E) 0 to 10 parts by moles of at least one hydrophobic monomer; and
(F) 0 to 30 parts by moles of at least one water-soluble monomer other than the monomers (A), (B), (C) and (D).

2. Water-soluble cationic copolymer according to Claim 1, characterized in that the compound(s) (A) of formula (I) is(are) preferably chosen from acrylamide, methacrylamide, N-isopropylacrylamide, N-ethoxypropyl-acrylamide, N,N-dimethylacrylamide, N- (2-hydroxy-propyl)acrylamide and N- (2-hydroxypropyl)methacrylamide.

3. Water-soluble cationic copolymer according to either of Claims 1 and 2, characterized in that the monomer(s) (B) of formula (II) is(are) chosen in particular from those for which:
R⁴ represents H ;
R⁵ represents -CH₃ ;
R⁶ represents -CH₃ or benzyl; and
X represents Cl; and the monomer(s)(B) of formula (III) is/are chosen from those for which:
R⁷ represents H;
R⁸ represents -CH₃;
R⁹ represents -CH₃ or benzyl; and
X represents Cl.

4. Water-soluble cationic copolymer according to one of claims 1 to 3, characterized in that the monomer(s) (C) is(are) chosen from ethylenically unsaturated carboxylic acids and salts thereof, and ethylenically unsaturated sulphonated monomers and salts thereof.

5. Water-soluble cationic copolymer according to claim 4, characterized in that the monomer(s) (C) is(are) chosen from acrylic acid and salts thereof and 2-acrylamido-2-methylpropanesulphonic acid and salts thereof.

6. Water-soluble cationic copolymer according to one of claim 1 to 5, characterized in that the monomer(s) (D) is(are) chosen from (meth)acryloyl-oxyethyltrimethylammonium halides.

7. Water-soluble cationic copolymer according to one of claims 1 to 6, characterized in that the monomer(s) (E) is(are) chosen from alkyl (meth)acrylates, such as ethyl acrylate and butyl acrylate, and vinylaromatic monomers, such as styrene.

8. Water-soluble cationic copolymer according to one of claims 1 to 7, characterized in that the water-soluble monomers (F) chosen from polyethoxylated (meth)acrylates, polyethoxylated (meth)acrylates containing hydrophobic units or aryl units, and N-vinylpyrrolidone.

9. Water-soluble cationic copolymer according to one of claims 1 to 8, characterized in that it is in the form of a dispersion in an organic solvent, an aqueous solution or a powder.

10. Process for manufacturing a copolymer as defined according to one of claims 1 to 9, characterized in that a free-radical (co)polymerization of the monomer(s) as defined according to one of claims 1 to 9, is carried out by inverse emulsion polymerization leading to a dispersion of the water-soluble (co)polymer in an organic solvent, or by aqueous solution polymerization leading to a polymer in the form of an aqueous solution or a powder.

11. Process according to claim 10, by inverse emulsion polymerization, characterized in that the monomer(s) is(are) emulsified in an organic phase using at least one organosoluble emulsifier, followed by emulsion polymerization.

12. Process according to claim 11, characterized in that the organic phase represents from 10% to 49% of the total weight of the emulsion.

13. Process according to either of claims 11 and 12, characterized in that the organic phase is chosen from xylene, toluene, mineral oils, kerosene, heavy spirits, petroleum and petroleum fractions.

14. Process according to one of claims 11 to 13, characterized in that the organosoluble emulsifier(s) is(are) chosen from those with an HLB value of between 2 and 10 and preferably between 3 and 9.

15. Process according to one of claims 11 to 14, charactereized in that the organosoluble emulsifier(s) is(are) chosen from fatty acid esters of mono-, di- and polyglycerides; fatty acid esters of sorbitan; fatty acid esters of mannitol; fatty acid esters of pentaerythritol, fatty acid esters of polyyethylene glycol sorbitan; fatty acid esters of glucose, trimethylolpropane distearate; the products of the reaction of isopropylamide with oleic acid; fatty acid esters of glycerolsorbitan; ethoxylated alkylamines; sodium hexadecyl phthalate; and sodium decyl phthalate.

16. Process according to one of claims 11 to 15, characterized in that the polymerization is carried out at a temperature of between 10 and 100° C. and preferably between 30 and 90° C.

17. Process according to one of claims 11 to 16, characterized in that the polymerization is carried out in the absence of oxygen.

18. Process according to one of claims 11 to 17, characterized in that the polymerization is carried out in the presence of at least one initiator, representing from 0.01% to 2% relative to the total weight of monomer(s) and preferably from 0.02% to 0.5%.

19. Process according to one of claims 11 to 18, characterized in that the initiator(s) is(are) chosen from peroxides, azo compounds and diazo compounds belonging to the family of carboxylic acid esters.

20. Process according to claim 10, by aqueous solution polymerization, characterized in that a stationary polymerization is carried out in water, at a monomer concentration of greater than 10% by weight, and in the presence of at least one water-soluble initiator in a proportion of from 0.01% to 2% by weight and preferably from 0.02% to 0.5% by weight relative to the monomer (s), the said polymerization leading to a polymer in the form of a hydrated gel which may be diluted with water to obtain a water-soluble aqueous solution with a concentration typically of less than 6%, or cut to size or precipitated and dried to obtain a powder.

21. Process according to claim 20, characterized in that the polymerization is carried out at a monomer concentration of from 20% to 60% by weight.

22. Process according to either of claims 20 and 21, characterized in that the water-soluble initiator(s) is(are) chosen from peroxides, persalts and azo compounds, which may be combined with organosoluble initiators.

23. Process according to one of claims 20 to 22, characterized in that the water-soluble initiator(s) is(are) combined with polymerization activators preferably chosen from metabisulphites and Fe²⁺.

24. Process according to one of claims 20 to 23, characterized in that the polymerization is carried out at a temperature of between 3 and 100° C. and preferably between 5 and 95° C.

25. Process according to one of claims 20 to 24, characterized in that the polymerization is initiated at low temperature, preferably between 5 and 20° C., and it is then allowed to proceed merely by the heat released by the polymerization reactor.

26. Use of a (co)polymer as defined in one of claims 1 to 19 prepared by a process as defined in one of claims 1 to 25, as a flocculant in the purification of urban and industrial waste waters, in the papermaking industry, in mines, quarries and drilling muds, in the assisted recovery of petroleum and in the treatment of drinking water.
